(19) United States
(12) Patent Application Publication
(10) Pub. No.: US 2024/0204295 A1
(43) Pub. Date: Jun. 20, 2024

(54) BATTERY MODULE AND BATTERY PACK INCLUDING THE SAME

(71) Applicant: SK ON CO., LTD., Seoul (KR)

(72) Inventor: Gang U LEE, Daejeon (KR)

(21) Appl. No.: 18/506,133

(22) Filed: Nov. 10, 2023

(30) Foreign Application Priority Data
Dec. 15, 2022 (KR) 10-2022-0175782

(51) Int. Cl. H01M 10/656; H01M 10/613; H01M 50/209; H01M 50/271

(52) U.S. Cl. CPC H01M 10/656; H01M 10/613; H01M 50/209; H01M 50/271

(57) ABSTRACT

A battery module, may include: a module housing having an internal space; a plurality of cell assemblies disposed in the internal space, the plurality of cell assemblies including a plurality of batter cells; and a crossmember disposed between the plurality of cell assemblies, wherein the crossmember may include a cooling flow path therein.

### CROSS-REFERENCE TO RELATED APPLICATION (S)

This patent document claims the priority and benefits of Korean Patent Application No. 10-2022-0175782 filed on Dec. 15, 2022, the disclosure of which is incorporated herein by reference in its entirety.

### TECHNICAL FIELD

The present disclosure relates to a battery module and a battery pack including the same.

### BACKGROUND

A secondary battery refers to a battery that can be repeatedly charged and discharged because mutual conversion between chemical energy and electrical energy is reversible.

Such a secondary battery may be used as an energy source for electric vehicles, hybrid vehicles, energy storage systems (ESSs), and the like, which have recently attracted attention, as well as mobile devices.

The secondary battery may be used in a form in which one or more battery cells made of a flexible pouch-type battery cell or a prismatic or cylindrical can-type battery cell having rigidity are electrically connected, and in particular, in the case of an electric vehicle requiring high-output power characteristics, it may be used in a form of a battery module in which one or more cell stacks in which a plurality of battery cells are stacked are electrically connected or a battery pack in which one or more battery modules are electrically connected.

Meanwhile, battery cells may generate heat during the charging and discharging process, and if the battery cells are not sufficiently cooled, heat may accumulate therein, which may lead to ignition or explosion in severe cases. Such a risk may be further increased in one or more battery packs, and accordingly, a component for cooling the battery cells including the same should be included in the battery module or battery pack.

In addition, an external impact may be applied to the battery pack while being mounted in a car, or the like, and in this case, deformation of the pack case, electrical short-circuits and/or disconnections, etc. may occur. Therefore, the battery pack should have sufficient structural rigidity to withstand external impacts, or the like, and to this end, a frame may be disposed.

In general, a conventional battery pack has a structure in which individual battery modules are mounted in a space inside a case partitioned by a frame, and a cooling system is disposed below the battery module. In such a structure, the frame only serves as a structure of the battery pack, and the cooling system disposed below the battery module should be manufactured to have a large size to cover all battery modules mounted on the case.

However, the conventional structure may have a problem that the size of the battery module is determined by an interval between the frames, and that excessive costs may be invested in manufacturing the cooling system. In addition, there may be a problem in that as more battery modules are installed in a battery pack, manufacturing tolerances accumulate and energy density of the battery pack decreases.

### SUMMARY

An aspect of the present disclosure is to provide a battery module in which a frame, which is a structure and a cooling system are integrated, and a battery pack including the same.

In addition, an aspect of the present disclosure is to provide a battery pack having increased energy density.

According to an aspect of the present disclosure, a battery module, may include: a module housing having an internal space; a plurality of cell assemblies disposed in the internal space, the plurality of cell assemblies including a plurality of battery cells; and a crossmember disposed between the plurality of cell assemblies, wherein the crossmember may include a cooling flow path therein.

According to an embodiment of the present disclosure, the plurality of battery cells may be arranged in a first direction, and the plurality of cell assemblies may be arranged in a second direction, perpendicular to the first direction.

According to an embodiment of the present disclosure, a plurality of end covers respectively closing the plurality of cell assemblies in the first direction may be further included, wherein the plurality of end covers may be coupled to the module housing and the crossmember.

According to an embodiment of the present disclosure, the crossmember may include a body portion extending in the first direction and facing the plurality of cell assemblies in the second direction; and an extension portion extending from both ends of the body portion in the second direction, and disposed to pass between the plurality of end covers.

According to an embodiment of the present disclosure, the extension portion may include a first extension portion coupled to the end cover; and a second extension portion disposed to be spaced apart from the first extension portion in a third direction, perpendicular to the first direction and the second direction, and protruding further in the first direction than the first extension portion.

According to an embodiment of the present disclosure, the plurality of battery cells may include a prismatic case; and an electrode terminal protruding from at least one side of the case.

According to an embodiment of the present disclosure, the crossmember may include a plurality of parts including a body portion extending in the first direction and facing the plurality of cell assemblies in the second direction; and an extension portion extending from both ends of the body portion in the second direction, wherein the crossmember may be formed by combining the plurality of parts.

According to an embodiment of the present disclosure, the plurality of parts may include the body portion having a flat-shaped region and the body portion having an irregular-shaped region, respectively.

According to an embodiment of the present disclosure, the plurality of parts may include a cooling flow path formed by combining a flat-shaped region of the body portion.

According to an aspect of the present disclosure, a battery pack, may include: a plurality of battery modules; and a pack housing in which the plurality of battery modules are disposed, wherein the plurality of battery modules may include a module housing having an internal space; a plurality of cell assemblies disposed in the internal space and including a plurality of battery cells arranged in a first direction; a crossmember disposed between the plurality of cell assemblies and including a cooling flow path; and a plurality of end covers respectively closing the plurality of cell assemblies in the first direction, wherein the crossmember may have one side coupled to the plurality of end covers, and the other side coupled to the pack housing.

According to an embodiment of the present disclosure, the plurality of cell assemblies may be arranged in a second direction, perpendicular to the first direction, and the crossmember may be alternately disposed with the plurality of cell assemblies in the second direction.

According to an embodiment of the present disclosure, the crossmember may include a body portion extending in the first direction and facing the plurality of cell assemblies in the second direction; and an extension portion extending from both ends of the body portion in the second direction, and disposed to pass between the plurality of end covers.

According to an embodiment of the present disclosure, the extension portion may include a first extension portion coupled to the end cover; and a second extension portion disposed to be spaced apart from the first extension portion in a third direction, perpendicular to the first direction and the second direction; and protruding further in the first direction than the first extension portion, wherein the second extension portion may be coupled to the pack housing.

According to an embodiment of the present disclosure, the pack housing may include a bottom frame on which the plurality of battery modules are seated; a plurality of first side frames disposed on the bottom frame to be spaced apart in the first direction; and a plurality of second side frames disposed on the bottom frame to be spaced apart in the second direction, wherein the first side frame and the second side frame may include a cooling flow path.

According to an embodiment of the present disclosure, the second extension portion may be disposed to overlap the first side frame in the first direction, and the cooling flow path of the pack housing and the cooling flow path of the crossmember may be connected to each other by the second extension portion.

According to an embodiment of the present disclosure, the second extension portion may include a connection protrusion protruding toward the first side frame, and the first side frame may include a groove in which the connection protrusion is accommodated.

According to an embodiment of the present disclosure, a support member disposed between the plurality of battery modules may be further included, wherein the support member may be coupled to the pack housing on both sides in a longitudinal direction.

According to an embodiment of the present disclosure, the plurality of battery modules may be disposed to be spaced apart in at least one among the first direction and a second direction, perpendicular to the first direction, and the support member may be disposed between the plurality of battery modules to be spaced apart in the second direction.

According to an embodiment of the present disclosure, the plurality of battery cells may include a prismatic case; and an electrode terminal protruding from at least one side of the case.

In some embodiments of the present disclosures, a battery module and a battery pack may efficiently utilize an internal space while securing structural rigidity, and energy density of the battery pack may be improved.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view of a battery module according to an embodiment of the present disclosure.

FIG. 2 is an exploded perspective view of a battery module according to an embodiment of the present disclosure.

FIG. 3 is a perspective view of a battery cell included in a battery module according to an embodiment of the present disclosure.

FIG. 4 is an enlarged view of region A of FIG. 1.

FIG. 5 is a perspective view of a crossmember according to an embodiment of the present disclosure.

FIG. 6 is a top view of a battery module according to an embodiment of the present disclosure.

FIG. 7 is a diagram for illustrating an example of expansion of a battery module according to an embodiment of the present disclosure.

FIG. 8 is a diagram illustrating a cooling flow path of a battery module according to an embodiment of the present disclosure.

FIG. 9 is an exploded perspective view of a battery pack according to an embodiment of the present disclosure.

FIGS. 10A and 10B are diagrams illustrating a state in which a battery module is coupled to a pack housing according to an embodiment of the present disclosure.

FIG. 11 is an enlarged view of region B in FIG. 10A.

FIGS. 12 and 13 are diagrams illustrating a configuration of a battery pack according to various embodiments of the present disclosure.

FIG. 14 is a diagram illustrating a cooling flow path of a battery pack according to an embodiment of the present disclosure.

### DETAILED DESCRIPTION

Prior to the detailed description of the present disclosure, the terms or words used in the present specification and claims described below should not be construed as being limited to a common or dictionary meaning, and the inventor intends to use his/her invention in the best way. Based on the principle that terms may be properly defined for description, they should be interpreted as meanings and concepts consistent with the technical spirit of the present disclosure. Therefore, the embodiments described in this specification and the configurations shown in the drawings are only the most preferred embodiments of the present disclosure, and do not represent all of the technical spirit of the present disclosure, so it should be understood that there may be various equivalents and modifications that can be substituted therefor at the time of this application.

Hereinafter, in preferred embodiments of the present disclosure, the same reference numbers or symbols in each drawing attached to this specification indicate parts or components that perform substantially the same function. For convenience of explanation and understanding, different embodiments may be described using the same reference numerals or symbol. That is, even if components having the same reference number are illustrated in a plurality of drawings, the plurality of drawings do not all represent one embodiment.

In the following description, singular expressions include plural expressions unless the context clearly dictates otherwise. The terms “include” or “comprise” are intended to indicate that there is a feature, number, step, operation, component, part, or combination thereof described in the specification, but it should be understood that the presence or addition of one or more other features or numbers, steps, operations, components, parts, or combinations thereof is not precluded in advance.

In addition, in the following description, terms such as a top side, a top portion, a lower side, a lower portion, a side surface, a front surface, a rear surface, or the like, are represented based on the directions in the drawings, and may be used differently if the direction of an element is changed.

In addition, terms including ordinal numbers such as “first” and “second” used herein may be used to describe various components, but the components are not limited by the terms, and the terms are used only for the purpose of distinguishing one component from another component. For example, a first element may be termed a second element, and similarly, a second element may be termed a first element without departing from the scope of right of the present invention.

Hereinafter, a battery module and a battery pack according to an embodiment of the present disclosure will be described with reference to the attached drawings.

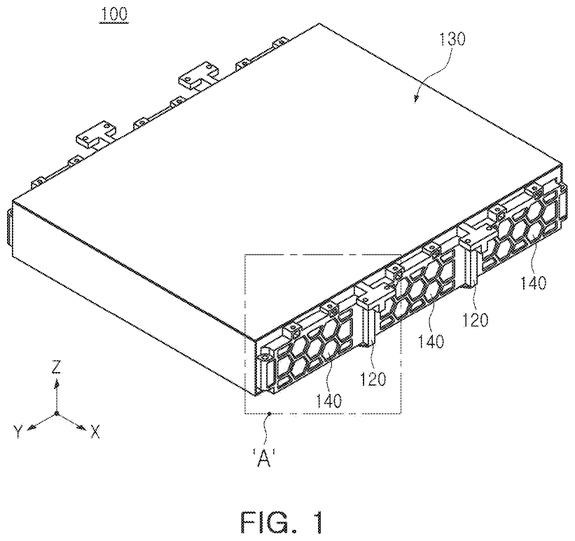

First, with reference to FIGS. 1 to 8, a battery module according to an embodiment of the present disclosure will be described.

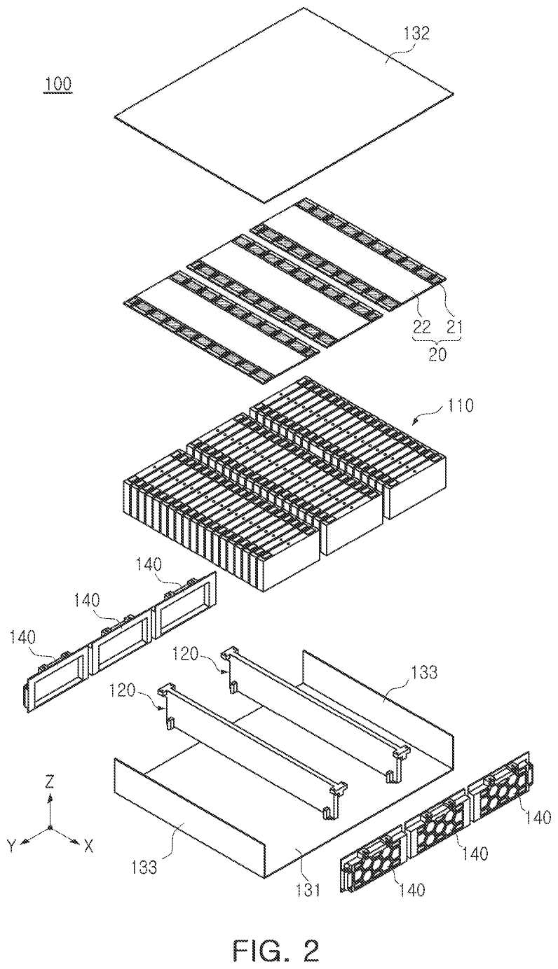

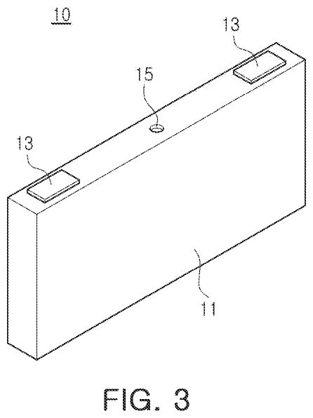

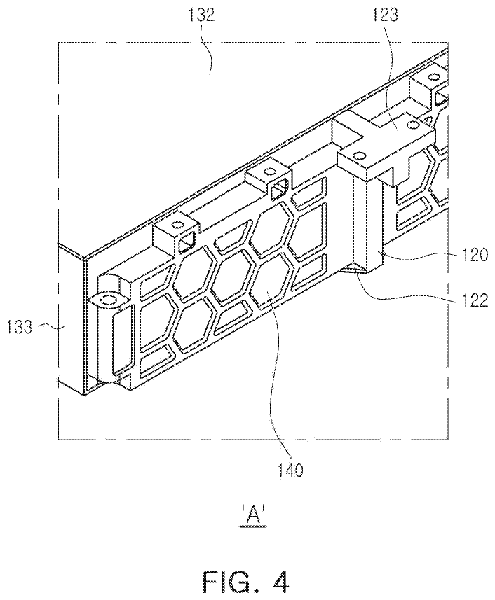

FIG. 1 is a perspective view of a battery module according to an embodiment of the present disclosure, FIG. 2 is an exploded perspective view of a battery module according to an embodiment of the present disclosure, FIG. 3 is a perspective view of a battery cell included in a battery module according to an embodiment of the present disclosure, and FIG. 4 is an enlarged view of region A of FIG. 1.

Referring to FIG. 1, a battery module 100 according to an embodiment of the present disclosure may include a plurality of assemblies 110, a crossmember 120 disposed between the cell assemblies 110, and a module housing 130 in which the cell assemblies 110 are accommodated.

The module housing 130 may form an internal space in which a plurality of cell assemblies 110 are accommodated. The module housing 130 may include a lower cover 131, a top cover 132, and a side cover 133, and these covers may form an internal space. Although it is illustrated that the lower cover 131 and the side cover 133 are integrally formed in FIG. 2, the lower cover 131 and the side cover 133 may be provided as separate components.

A plurality of cell assemblies 110 may be accommodated in the module housing 130. In an embodiment, referring to FIG. 2, three cell assemblies 110 may be accommodated in the module housing 130, and each of the cell assemblies 110 may be arranged in a Y-direction (or second direction) in the module housing 130.

The cell assembly 110 may include a plurality of battery cells 10 arranged in one direction. In an embodiment, referring to FIG. 2, the plurality of battery cells 10 may be arranged in an X-direction (or first direction). That is, the arrangement direction of the plurality of battery cells 10 and the arrangement direction of the cell assembly 110 may intersect each other.

As illustrated in FIG. 3, the battery cell 10 according to an embodiment of the present disclosure may be a prismatic battery cell. The prismatic battery cell may refer to a battery cell in which a case containing an electrode assembly and an electrolyte has a flat and angular shape. Referring to the drawings, the plurality of battery cells 10 may be arranged in an X-direction so that a wide surface of the case 11 faces each other.

Referring to FIG. 3, the battery cell 10 may include an electrode terminal 13 for electrical connection and a venting portion 15 for discharging gas generated inside the case 11 externally on one side of the case 11. In an embodiment, referring to FIG. 2, the plurality of battery cells 10 may be arranged so that one side of the case 11 including the electrode terminal 13 and the venting portion 15 faces a z direction.

The cell assembly 110 may include a busbar assembly 20 disposed on one side of the plurality of battery cells 10. The busbar assembly 20 may include a busbar 21 electrically connected to the electrode terminal 13 and a busbar frame 22 on which the busbar 21 is disposed. In addition, the busbar assembly 20 may include a substrate electrically connected to the busbar 21 and receiving a voltage, temperature information, and the like of the plurality of battery cells 10.

The busbar frame 22 may be formed of an insulating material and, for example, may be disposed to entirely cover one side of the plurality of battery cells 10. A busbar 21 electrically connecting the electrode terminals 13 of adjacent battery cells 10 to each other may be disposed on the busbar frame 22.

Referring to FIG. 2, the battery module 100 may include an end cover 140 disposed to cover the cell assembly 110 on one side thereof. The end cover 140 may be provided as a pair, and may be disposed to cover the cell assembly 110 on both sides of the plurality of battery cells 10 in a X-direction in which the plurality of battery cells 10 are arranged.

In an embodiment, the end covers 140 may be provided in an amount corresponding to that of the plurality of cell assemblies 110 and disposed to cover the plurality of cell assemblies 110, respectively. This is related to a structure in which the crossmember 120 is disposed between the plurality of cell assemblies 110, and a description thereof will be provided later. However, even when the crossmember 120 is disposed, the plurality of assemblies 110 may be covered by a pair of end covers 140, and in this case, the pair of end covers 140 may include a groove through which the crossmember 120 is disposed.

Since the end cover 140 forms an exterior of the battery module 100 together with the module housing 130, the end cover 130 may be formed of a material with structural rigidity and can protect the cell assembly 110, or the like, from external shock. For example, the end cover 140 may be formed of aluminum or a material containing aluminum.

Referring to FIG. 4, the end cover 140 may be combined with the module housing 130. For example, a top side of the end cover 140 may be coupled to be in contact with a top cover 132 by welding, and a bottom side of the end cover 140 may be coupled to be in contact with a bottom cover 131 by welding. Among the plurality of end covers 140, one side of the end cover 140 disposed at an edge may be coupled to be in contact with a side cover 133 by welding. In addition, among the plurality of end covers 140, the other side of the end cover 140 disposed at an edge and both sides of the end cover 140 disposed other than the edge may be coupled to be in contact with the crossmember 120 by welding.

However, a coupling method between the end cover 140 and other members is not limited thereto, and may also be coupled using a separate fastening member (for example, bolts).

The battery module 100 according to an embodiment of the present disclosure may include one or more crossmembers 120 disposed between a plurality of cell assemblies 110.

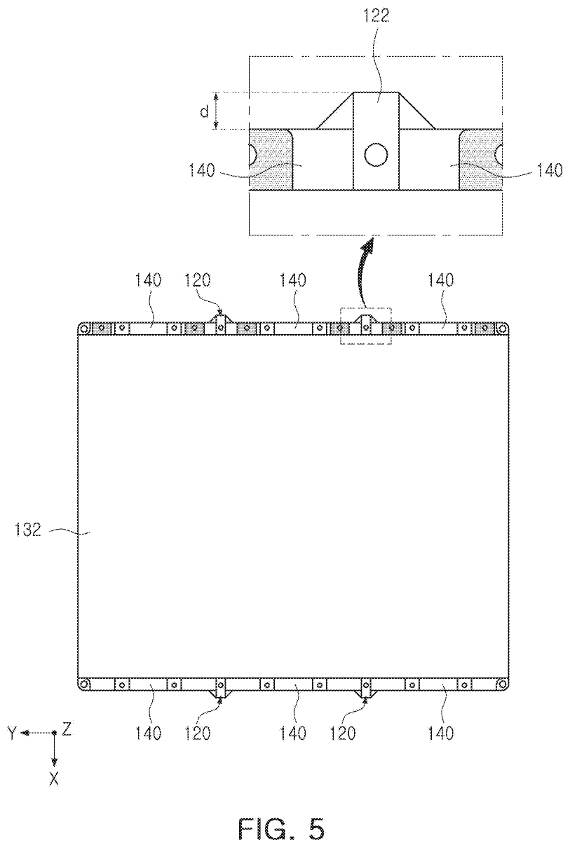

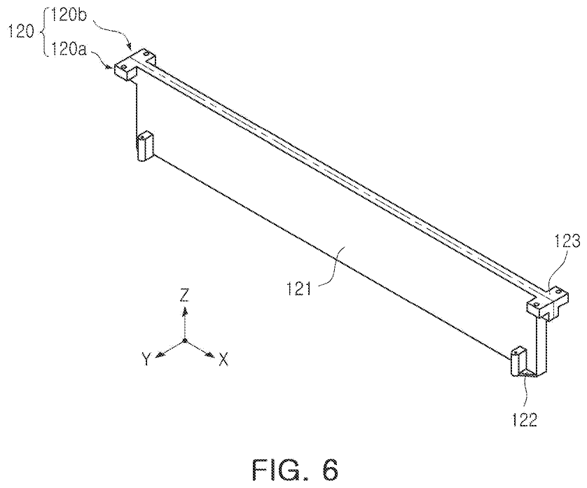

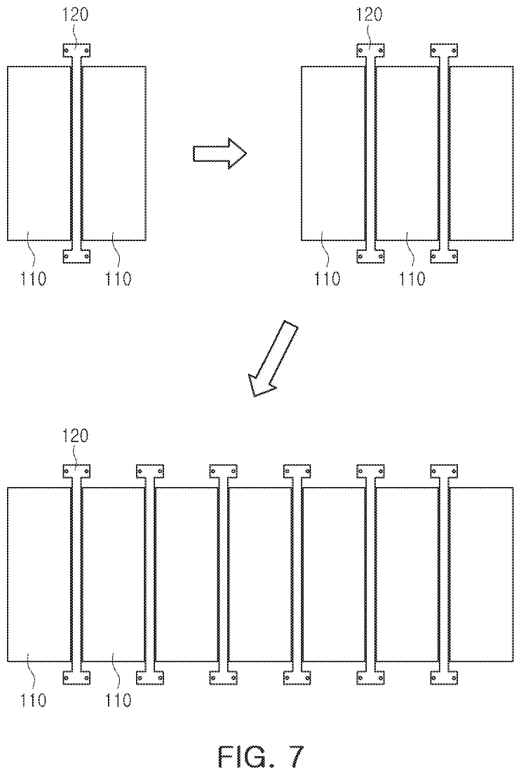

FIG. 5 is a perspective view of a crossmember 120 according to an embodiment of the present disclosure, FIG. 6 is a top view of a battery module according to an embodiment of the present disclosure, and FIG. 7 is a diagram for illustrating an example of expansion of a battery module according to an embodiment of the present disclosure.

The crossmember 120 may be disposed across an internal space of the module housing 130 to partition the internal space. For example, the crossmember 120 may be disposed to be spaced apart in a Y-direction within the module housing 130, and may partition the internal space of the module housing 130 along the Y-direction. The plurality of cell assemblies 110 may be respectively disposed in a space partitioned by the crossmember 120.

The cell assembly 110 and the crossmember 120 may be alternately disposed in the Y-direction in the internal space of the battery module 100. For example, the battery module 100 may include n (n: a natural number greater than or equal to 2) number of cell assemblies 110 and n−1 number of crossmembers 120.

In the battery module 100, the crossmember 120 may be disposed so that one surface of the body portion 121 and the other surface of the body portion 121 face cell assemblies 110, disposed adjacently in the Y-direction, respectively. In addition, since the body portion 121 extends in a direction in which the plurality of battery cells 10 are arranged, in a state disposed as above, the body portion 121 may also face a plurality of battery cells 10 included in the cell assembly 110 in the Y-direction.

The crossmember 120 may be formed of a material having rigidity, for example, aluminum or a material containing aluminum. The crossmember 120 may cooperate with the module housing 130 to structurally support the battery module 100 and reinforce rigidity thereof.

In addition, at least a portion of the crossmember 120 may be exposed externally of the battery module 100, and serve as a structure used to fix the battery module 100 to another member (e.g., a pack housing of a battery pack).

The battery module 100 may be manufactured in various sizes by adjusting the number of cell assemblies 110 and crossmembers 120. For example, referring to FIG. 7, the battery module 100 may have two cell assemblies 110 and one crossmember 120 as basic units, and in the battery module 100, the crossmember 120 and the cell assembly 110 may be additionally disposed in a Y-direction and a structure of the battery module 100 may be freely expanded.

According to an embodiment of the present disclosure, a battery pack 1000, to be described later, does not have a separate partition wall to partition a space in the pack housing 1100 in which the battery module 100 is disposed, but the crossmember 120 of the battery module 100 is directly coupled to the pack housing 1100 to serve as a partitional wall, so that there are fewer space restrictions, and accordingly, the battery module 100 can freely expand along the Y-direction within a length of a long side of the pack housing 1100.

Referring to FIG. 5, the crossmember 120 may include a body portion 121 disposed between the cell assemblies 110 and extending in an X-direction in which a plurality of battery cells 10 are arranged, and a first extension portion 122 and a second extension portion 123 extending from both ends of the body portion in a longitudinal direction in a Y-direction, perpendicular to the X-direction.

The first extension portion 122 and the second extension portion 123 may be formed at different heights in a z-direction (or a third direction) at both ends of the body portion 121 in the longitudinal direction. For example, based on a height direction of the body portion 121, the first extension portion 122 may be formed on a bottom side, and the second extension portion 123 may be formed on a top side.

The body portion 121 may extend in an X-direction to partition an internal space of the module housing 130. In more detail, a length of the body portion 121 in the X-direction may be longer than a length of the module housing 130 in the X-direction. Accordingly, the first extension portion 122 and the second extension portion 123 provided at both ends of the body portion 121 in the longitudinal direction may be exposed externally of the module housing 130.

For example, referring to FIG. 6, the first extension portion 122 of the crossmember 120 may be formed between end covers 140 covering adjacent cell assemblies 110, to be longer than the end cover 140 in the X-direction by a predetermined length (d) in the X-direction between the end covers 140 and disposed to protrude externally of the battery module 100. The first extension portion 122 may contact the end cover 140 in the X-direction, and the portion in which the first extension portion 122 is in contact with the end cover 140 may be coupled by welding.

The second extension portion 123 may be formed to be longer in the X-direction than the first extension portion 122. Accordingly, the second extension portion 123 may be disposed to overlap a pack housing 1100, to be described later, in the X-direction. In addition, an inlet and an outlet for supplying and discharging coolant may be connected to the second extension portion 123. An explanation regarding the same will be provided later.

The crossmember 120 may be formed by combining two identical parts 120a and 120b manufactured using a die casting method. For example, each part may include a body portion 121 and portions of the first extension portion 122 and the second extension portion 123. The first extension portion 122 and the second extension portion 123 may have a shape extending to both sides in a +Y-direction and −Y-direction based on the body portion 121, and each part may only include a portion extending in the +Y-direction or −Y-direction based on the body portion 121.

In addition, each part 120a and 120b may include half of the body portion 121. Although not specifically illustrated in the drawings, the body portion of each part 120a and 120b may include a portion having a flat shape and a portion having an irregular shape, and when the two parts 120a and 120b are combined, the portion having a flat shape may include a cooling flow path.

That is, according to an embodiment of the present disclosure, the crossmember may serve as a structure of the battery module 100 supporting a plurality of cell assemblies 110 and at the same time, serve as a heat sink for cooling a plurality of battery cells 10.

As illustrated in the attached drawing, the crossmember 120 is disposed so that both surfaces of the body portion 121 face the plurality of battery cells 10 included in the cell assembly 110 disposed adjacently, so that cooling of the plurality of battery cells 10 may be performed by having a cooling flow path.

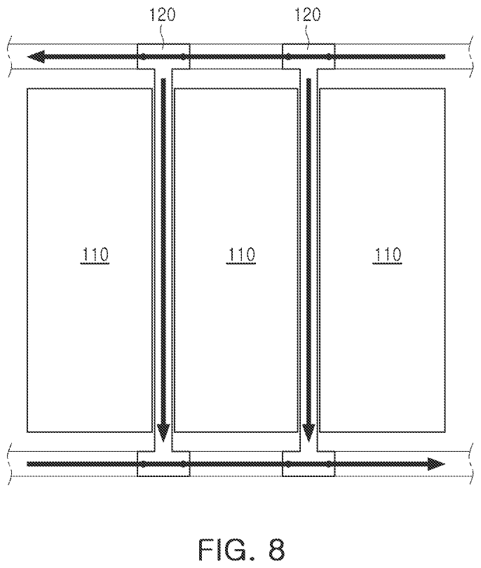

FIG. 8 is a diagram illustrating a cooling flow path of a battery module according to an embodiment of the present disclosure.

Referring to FIG. 8, a battery module 100 may be cooled on side surfaces of a plurality of cell assemblies 110 by a crossmember 120 disposed between the plurality of cell assemblies 110. The plurality of cell assemblies 110 may be cooled on one side surface or both side surfaces thereof.

In a state in which the battery module 100 is disposed in a battery pack 1000, coolant may be supplied to a cooling flow path included in a body portion 121 through a second extension portion 123 connected to a pack housing 1100, and coolant may flow in one direction within a cooling flow path. In addition, the coolant flowing through the cooling flow path may be discharged externally through the second extension portion 123 and the pack housing 1100.

According to an embodiment of the present disclosure, the battery module 100 may further include a heat dissipation member (not shown) disposed between the plurality of cell assemblies 110 and the crossmember 120. For example, the heat dissipation member may be provided as a thermally conductive adhesive.

One surface of the heat dissipation member may be in contact with the cell assembly 110, and the other surface of the heat dissipation member may be in contact with the crossmember 120. That is, the heat dissipation member may be disposed to fill an interval between the cell assembly 110 and the crossmember 120 so that heat exchange between the cell assembly 110 and the crossmember 120 may be performed more actively. Accordingly, heat dissipation efficiency of the battery module 100 may be increased.

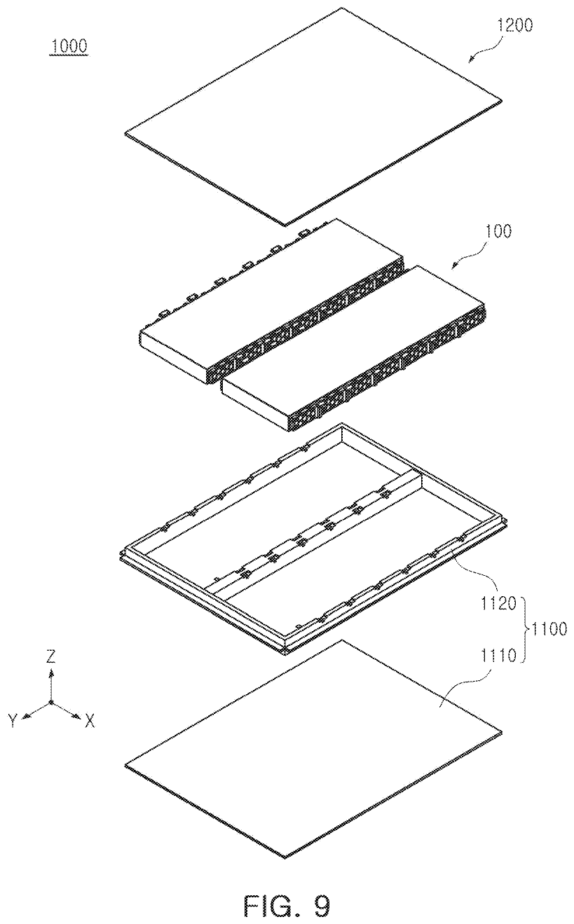

Next, with reference to FIGS. 9 to 14, a battery pack according to an embodiment of the present disclosure will be described. A battery pack 1000 according to an embodiment of the present disclosure may include the battery module 100 described above.

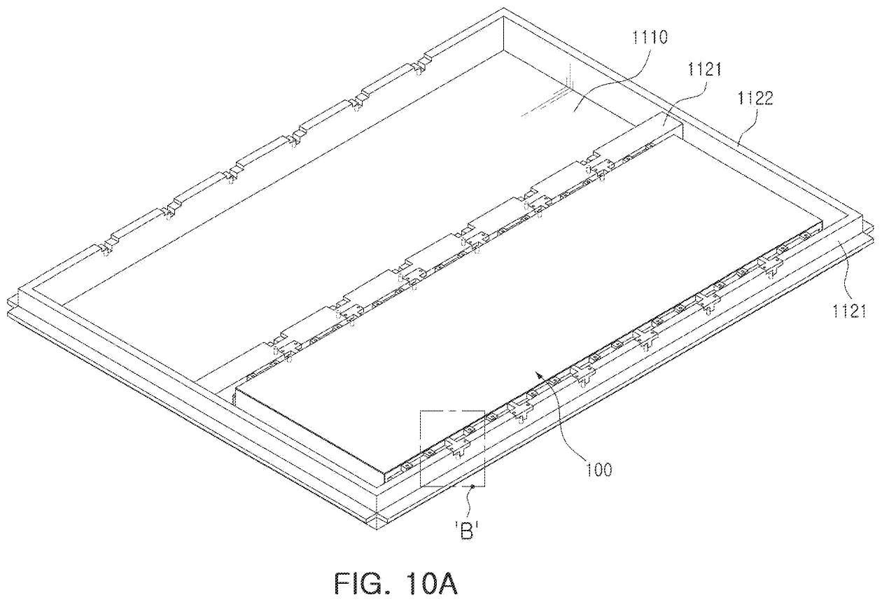

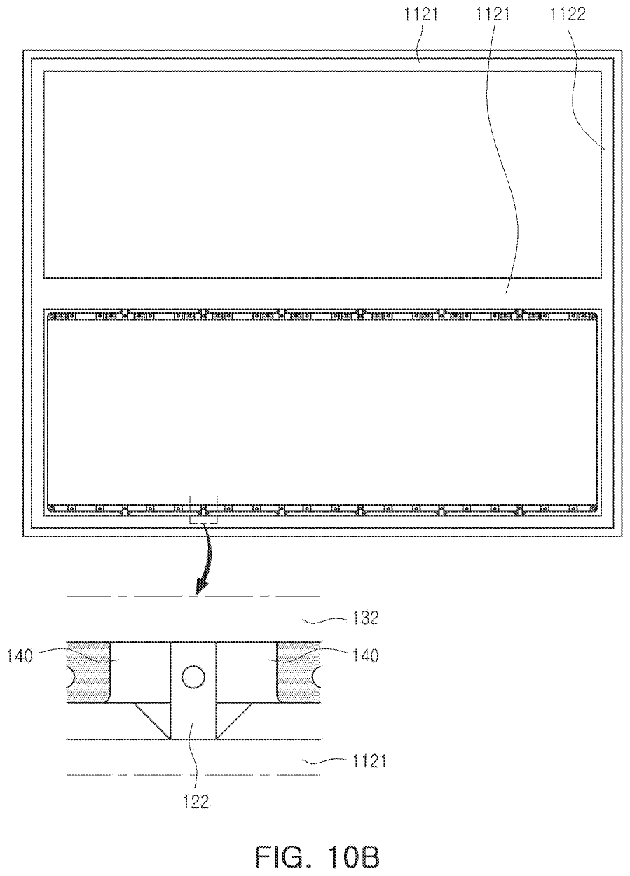

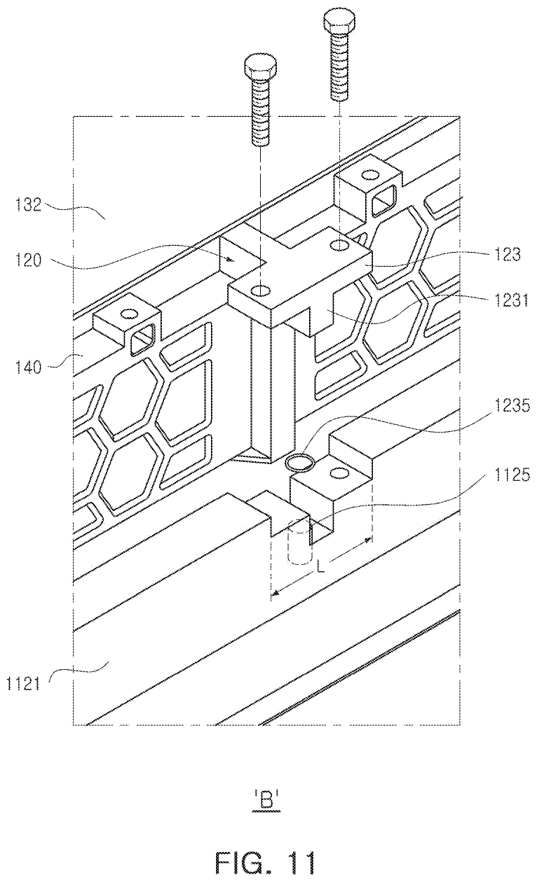

FIG. 9 is an exploded perspective view of a battery pack according to an embodiment of the present disclosure, FIGS. 10A and 10B are diagrams illustrating a state in which a battery module is coupled to a pack housing according to an embodiment of the present disclosure and FIG. 11 is an enlarged view of region B in FIG. 10A.

Referring to FIG. 9, a battery pack 1000 according to an embodiment of the present disclosure may include a plurality of battery modules 100, a pack housing 1100 in which the plurality of battery modules 100 are accommodated, and a pack cover 1200 coupled to the pack housing 1100 to cover an internal space.

The battery pack 1000 may include at least two battery modules 100. The plurality of battery modules 100 may be accommodated in the pack housing 1100 and electrically connected to each other. The plurality of battery modules 100 may be connected to each other in series or parallel. Overlapping descriptions of the battery module 100 will be replaced with the above-described contents.

The pack housing 1100 may include a bottom frame 1110 on which the plurality of battery modules 100 are seated and a side frame 1120 facing a side surface of the battery module 100. The bottom frame 1110 and the side frame 1120 may be coupled to each other. For example, one side of the side frame 1120 may be coupled to the bottom frame 1110, and the other side may be coupled to the pack cover 1200.

The side frame 1120 may include a first side frame 1121 disposed in an X-direction on the bottom frame 1110 and a second side frame 1122 disposed in a Y-direction on the bottom frame 1110. The first side frame 1121 and the second side frame 1122 may be disposed along an edge of the bottom frame 1110 to form a side surface of the battery pack 1000. In addition, a portion of the first side frame 1121 may be disposed to partition an internal space of the pack housing 1100 in the X-direction.

A plurality of battery modules 100 may be disposed between two neighboring first side frames 1121 within the pack housing 1100. The first side frame 1121 may face at least one battery module 100 in the X-direction. In an embodiment of the present disclosure, the end cover 140 closes the battery module 100 in the X-direction, so the first side frame 1121 may face the end cover 140 in the X-direction.

Meanwhile, as described above, the battery module 100 according to an embodiment of the present disclosure may be manufactured in various sizes by adjusting the number of cell assemblies 110 and crossmembers 120, and may include battery modules 100 of various sizes.

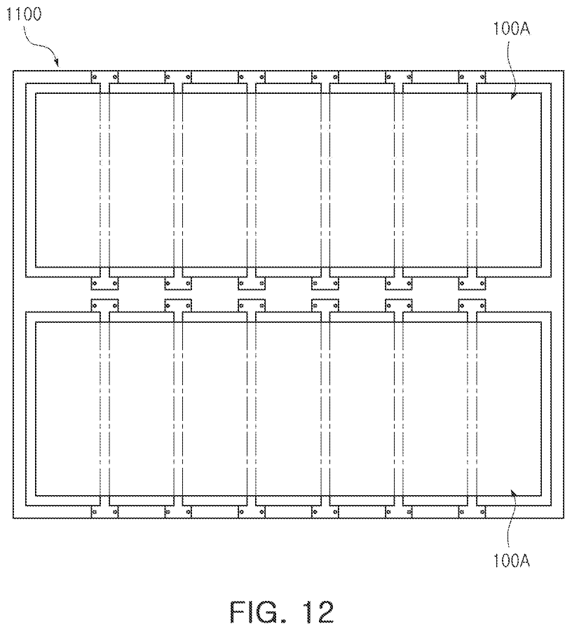

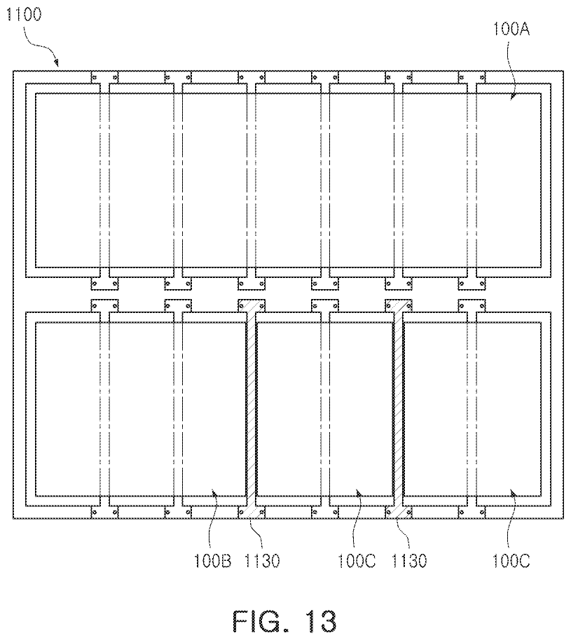

FIGS. 12 and 13 are diagrams illustrating a configuration of a battery pack according to various embodiments of the present disclosure.

In an embodiment, one or more battery modules 100 may be disposed in the same configuration in a space between two neighboring first side frames 1121 in the battery pack 1000.

For example, one battery module 100A of approximately the same size as a length of a long side (Y-direction) of the pack housing 1100 may be disposed in each space. Referring to FIG. 12, a battery module 100A including seven cell assemblies 110 may be disposed in the space between two neighboring first side frames 1121 in the battery pack 1000, respectively. Such a battery module 100A may include six crossmembers 120.

As illustrated in FIG. 12, the pack housing 1100 may not include a separate partition or frame disposed to partition an internal space, except for the first side frame 1121 disposed to partition the internal space (The first side frame 1121 may be provided to cool the plurality of battery modules 100). Therefore, when one battery module 100 is disposed in the space between two neighboring first side frames 1121, respectively, the battery module 100 may be provided in an expanded form as much as possible within the long side (Y-direction) length of the pack housing 1100. The crossmember 120 disposed between the cell assemblies 110 in the battery module 100 may serve as a partition wall.

Meanwhile, the crossmember 120 may serve as a heat sink for cooling the battery module 100, and the cell assembly 110 and the crossmember 120 may be disposed as close to each other as possible for efficient cooling. Accordingly, dead space is reduced compared to a structure in which a battery module is disposed in a plurality of spaces pre-partitioned by the conventional partition wall, or the like, and the internal space of the pack housing 1100 may be utilized efficiently.

Alternatively, although not illustrated in the drawing, two or more battery modules of various sizes combined to have a size approximately equal to the length of the long side (Y-direction) of the pack housing 1100 may be disposed in a space between the two neighboring first side frames 1121.

In another embodiment, one or more battery modules 100 may be disposed as a different component in the space between two neighboring first side frames 1121 in the battery pack 1000.

For example, one battery module 100A having a size approximately equal to the length of the long side (Y-direction) of the pack housing 1100 may be disposed in one space, and two or more battery modules 100B and 100C of various sizes combined to have a size approximately equal to the length of the long side (Y-direction) of the pack housing 1100 may be disposed in the other space.

Referring to FIG. 13, a battery module (hereinafter, referred to as a first battery module) 100A illustrated in FIG. 12 may be disposed in one of the spaces between two neighboring first side frames 1121 in the battery pack 1000, and one battery module 100B (hereinafter, referred to as a second battery module) including three cell assemblies 110 and two battery modules 100C (hereinafter, referred to as a third battery module) including two cell assemblies 110 may be disposed in the other thereof. Referring to FIG. 13, a support member 1130 may be disposed between the battery modules 100B and 100C disposed adjacent to each other in the space between two neighboring first side frames 1121. The support member 1130 may serve as a partition wall partitioning a space in which the battery module 100 is disposed.

In other words, according to an embodiment of the present disclosure, since the battery module 100 includes a crossmember 120 functioning as a partition wall, the pack housing 1100 may not include a separate partition wall partitioning an internal space in a Y-direction, in addition to the first side frame 1121, but as illustrated in FIG. 13, when a plurality of battery modules 100B and 100C are disposed in a space between two neighboring first side frames 1121, a support member 1130 may be alternately disposed with the battery modules 100B and 100C in the Y-direction. The support member 1130 may face the crossmember 120 disposed at a corresponding position in another space in an X-direction.

The support member 1130 may be disposed between battery modules 100 and may only function as a partition wall to spatially separate adjacent battery modules 100 and may not include a cooling flow path. Accordingly, unlike the crossmember 120 disposed in the battery module 100, the support member 1130 may not have a heat sink function.

In a state in which the support member 1130 disposed in the internal space of the pack housing 1100, one side of the first extension portion of the support member 1130 may contact the end cover 140 of the battery module 100 in the X-direction, the other side of the first extension portion of the support member 1130 may contact the side frame 1121 of the pack housing 1100 in the X-direction, and the support member 1130 may be coupled to the battery module 100 and the pack housing 1100 through the contact portion.

In addition to the information described above, the shape of the support member 1130 and the method of coupling with surrounding components may be the same as those of the crossmember 120.

The plurality of battery modules 100 may be coupled to a first side frame 1121 of the pack housing 1100. For example, the plurality of battery modules 100 may be coupled to the first side frame 1121 through a crossmember 120 extending in the X-direction and protruding externally of the battery module 100.

Referring to FIG. 10B, a length of the crossmember 120 in the X-direction may be approximately equal to an interval between two neighboring first side frames 1121. For example, a length between first extension portions 122 formed at both ends of the crossmember 120 in a longitudinal direction may be approximately equal to the interval between the two neighboring first side frames 1121, but may be shorter than the interval between the first side frame 1121. Accordingly, the battery module 100 may be disposed between two neighboring first side frames 1121, and in this case, one side of the first extension portion 122 of the crossmember 120 may be in contact with the two neighboring first side frames 1121 in the X-direction, respectively.

The first extension portion 122 and the first side frame 1121 may be coupled by welding. For example, the first extension portion 122 of the crossmember 120 may contact the first side frame 1121, and welding may be performed in a height direction of the pack housing 1100 in the portion in which the first extension portion 122 of the cross member 120 is in contact with the first side frame 1121. However, a method of coupling the first extension 122 and the first side frame 1121 is not limited thereto.

Referring to FIGS. 10A and 11, the battery module 100 may partially overlap the first side frame 1121 in an X-direction. For example, a length between second extension portions 123 formed at both ends of the crossmember 120 in a longitudinal direction may be approximately equal to an interval between the two neighboring first side frames 1121, but may be longer than the interval between the first side frames 1121. In addition, the first side frame 1121 may have a bottom height than the battery module 100 in at least a portion of a section L. The section L may be one continuous section or may be comprised of a plurality of discontinuous sections. Accordingly, the second extension portion 123 of the crossmember 120 may be disposed to overlap the first side frame 1121 in the section L.

The second extension portion 123 and the first side frame 1121 may be coupled to each other using a separate fastening member (e.g., bolts). However, a method of coupling the second extension portion 123 and the first side frame 1121 is not limited thereto, and the coupling method using welding or an adhesive may also be used.

The second extension portion 123 may be connected to an inlet and outlet in a portion overlapping the first side frame 1121. For example, the second extension portion 123 formed on one side of the body portion 121 may be connected to the inlet, and the second extension portion 123 formed on the other side thereof may be connected to the outlet.

Referring to FIG. 11, the second extension portion 123 may include a connection protrusion 1231 protruding toward a first side frame 1121 to be connected to a cooling flow path (not shown) formed in the first side frame 1121, and the first side frame 1121 may include a hole or groove 1125 of a shape corresponding thereto. In addition, as illustrated in the drawing, a sealing portion 1235 formed of an elastic material can be fitted into the connection protrusion 1231, and watertightness can be secured.

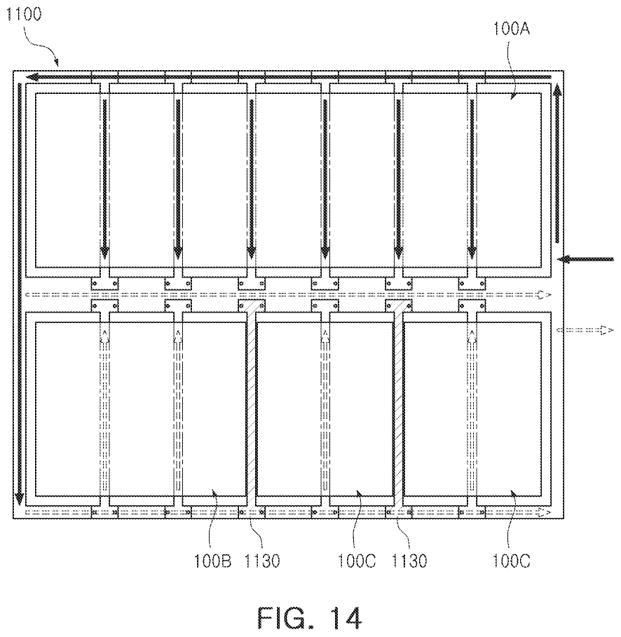

FIG. 14 is a diagram illustrating a cooling flow path of a battery pack according to an embodiment of the present disclosure.

A battery pack 1000 according to an embodiment of the present disclosure may be provided with a cooling module for cooling a battery module 100 on a side surface of a pack housing 1100. A side frame 1120 may include a cooling flow path, and coolant may flow along a cooling flow path formed in a first side frame 1121 and a second side frame 1122.

The cooling flow path included in the first side frame 1121 and the cooling flow path included in the second side frame 1122 may communicate with each other. In addition, the cooling flow path included in the first side frame 1121 may communicate with a cooling flow path of a crossmember 120 coupled to the first side frame 1121.

Referring to FIG. 14, the pack housing 1100 may include an inlet for supplying coolant and an outlet for discharging coolant on one side. Coolant may be supplied and discharged through the side frame 1120, for example, coolant may be supplied and discharged through the second side frame 1122.

The coolant supplied to the second side frame 1122 may flow toward the first side frame 1121, and then be branched into a plurality of crossmembers 120 coupled to the first side frame 1121 or the second side frame 1122. The coolant flowing inside the crossmember 120 may cool at least one side of a cell assembly 110 included in the battery module 100. The coolant flowing along the plurality of crossmembers 120 may be combined in the first side frame 1121, more specifically, in the first side frame 1121 disposed to partition an internal space of the pack housing 1100, and may be discharged externally through the second side frame 1122.

Meanwhile, as described above, a support member 1130 disposed between the plurality of battery modules 100 does not include a cooling flow path, so the support member 1130 may not form a cooling flow path.

The battery pack 1000 according to an embodiment of the present disclosure may use the crossmember 120 disposed between the side frame 1120 of the pack housing 1100 and the cell assembly 110 as a cooling module, so that there is no need to provide a separate cooling module. Accordingly, the internal space of the battery pack 1000 may be utilized efficiently, thereby improving energy density, and reducing production costs of the battery pack 1000.

In addition, since the cell assembly 110 and the crossmember 120 are alternately disposed from a perspective of the battery module 100 and the battery pack 1000, structural rigidity may be sufficiently secured, and at the same time, cooling is performed on at least one surface of the cell assembly 110, so that cooling efficiency may be improved.

As set forth above, according to an embodiment of the present disclosure, a battery module and a battery pack may efficiently utilize an internal space while securing structural rigidity, and energy density of the battery pack may be improved.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed to have a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A battery module, comprising:
a module housing having an internal space;
a plurality of cell assemblies disposed in the internal space, the plurality of cell assemblies including a plurality of batter cells; and
a crossmember disposed between the plurality of cell assemblies,
wherein the crossmember includes a cooling flow path therein.

2. The battery module of claim 1, wherein the plurality of battery cells are arranged in a first direction, and the plurality of cell assemblies are arranged in a second direction, perpendicular to the first direction.

3. The battery module of claim 2, further comprising:
a plurality of end covers respectively closing the plurality of cell assemblies in the first direction,
wherein the plurality of end covers are coupled to the module housing and the crossmember.

4. The battery module of claim 3, wherein the crossmember comprises a body portion extending in the first direction and facing the plurality of cell assemblies in the second direction; and
an extension portion extending from both ends of the body portion in the second direction, and disposed to pass between the plurality of end covers.

5. The battery module of claim 4, wherein the extension portion comprises s a first extension portion coupled to the end cover; and
a second extension portion disposed to be spaced apart from the first extension portion in a third direction, perpendicular to the first direction and the second direction, and protruding further in the first direction than the first extension portion.

6. The battery module of claim 1, wherein the plurality of battery cells comprise a prismatic case; and
an electrode terminal protruding from at least one side of the case.

7. The battery module of claim 2, wherein the crossmember is provided with a plurality of parts including a body portion extending in the first direction and facing the plurality of cell assemblies in the second direction, and an extension portion extending from both ends of the body portion in the second direction, wherein the crossmember is formed by combining the plurality of parts.

8. The battery module of claim 7, wherein the plurality of parts comprise the body portion having a flat-shaped region and the body portion having an irregular-shaped region, respectively.

9. The battery module of claim 8, wherein the plurality of parts comprise a cooling flow path formed by combining a flat-shaped region of the body portion.

10. A battery pack, comprising:
a plurality of battery modules; and
a pack housing in which the plurality of battery modules are disposed,
wherein the plurality of battery modules include a module housing having an internal space;
a plurality of cell assemblies disposed in the internal space, the plurality of cell assemblies including a plurality of battery cells arranged in a first direction;
a crossmember disposed between the plurality of cell assemblies, the crossmember including a cooling flow path; and
a plurality of end covers respectively closing the plurality of cell assemblies in the first direction,
wherein the crossmember has one side coupled to the plurality of end covers, and the other side coupled to the pack housing.

11. The battery pack of claim 10, wherein the plurality of cell assemblies are arranged in a second direction, perpendicular to the first direction, and the crossmember is alternately disposed with the plurality of cell assemblies in the second direction.

12. The battery pack of claim 10, wherein the crossmember comprises a body portion extending in the first direction and facing the plurality of cell assemblies in the second direction; and
an extension portion extending from both ends of the body portion in the second direction, and disposed to pass between the plurality of end covers.

13. The battery pack of claim 12, wherein the extension portion comprises a first extension portion coupled to the end cover; and
a second extension portion disposed to be spaced apart from the first extension portion in a third direction, perpendicular to the first direction and the second direction, and protruding further in the first direction than the first extension portion,
wherein the second extension portion is coupled to the pack housing.

14. The battery pack of claim 13, wherein the pack housing comprises
a bottom frame on which the plurality of battery modules are mounted;
a plurality of first side frames disposed on the bottom frame to be spaced apart in the first direction; and
a plurality of second side frames disposed on the bottom frame to be spaced apart in the second direction,
wherein the first side frame and the second side frame include a cooling flow path.

15. The battery pack of claim 14, wherein the second extension portion is disposed to overlap the first side frame in the first direction, and
a cooling flow path of the pack housing and a cooling flow path of the crossmember are connected to each other by the second extension portion.

16. The battery pack of claim 15, wherein the second portion comprises a connection protrusion extension protruding toward the first side frame, and the first side frame comprises a groove in which the connection protrusion is accommodated.

17. The battery pack of claim 10, further comprising:
a support member disposed between the plurality of battery modules, wherein the support member is coupled to the pack housing on both sides in a longitudinal direction.

18. The battery pack of claim 17, wherein the plurality of battery modules are disposed to be spaced apart in at least one direction among the first direction and a second direction, perpendicular to the first direction, and
the support member is disposed between the plurality of battery modules, disposed to be spaced apart in the second direction.

19. The battery pack of claim 10, wherein the plurality of battery cells comprise
a prismatic case; and
an electrode terminal protruding from at least one side of the case.
